(19) United States
(12) Patent Application Publication
(10) Pub. No.: US 2024/0408554 A1
(43) Pub. Date: Dec. 12, 2024

(54) MEMBRANE SOLVENT EXTRACTION PROCESS FOR SEPARATING LITHIUM FROM ALUMINUM

(71) Applicant: UT-Battelle, LLC, Oak Ridge, TN (US)

(72) Inventors: Ramesh R. Bhave, Oak Ridge, TN (US); Syed Z. Islam, Oak Ridge, TN (US); M. Parans Paranthaman, Oak Ridge, TN (US); Priyesh A. Wagh, Lakewood, OH (US)

(21) Appl. No.: 18/734,407

(22) Filed: Jun. 5, 2024

Related U.S. Application Data
(60) Provisional application No. 63/471,289, filed on Jun. 6, 2023.

(51) Int. Cl. B01D 69/08; B01D 71/26; B01J 20/04

(52) U.S. Cl. CPC B01D 69/08; B01D 71/262; B01J 20/041; B01D 2325/12; B01D 2325/38

(57) ABSTRACT

A method of separating lithium (Li) from aluminum (Al) includes: obtaining an aqueous feed solution containing an acid, Li, and Al; providing a membrane module including a plurality of hollow fibers that are hydrophobic and include a porous sidewall defining a lumen side spaced apart from a shell side; wetting the porous sidewall of the plurality of hollow fibers with an organic phase including a cationic extractant and an organic solvent such that the organic phase is immobilized in the porous sidewall; performing membrane solvent extraction by passing the feed solution along one of the lumen side or the shell side of the plurality of hollow fibers and simultaneously passing a strip solution along the other of the lumen side or the shell side of the plurality of hollow fibers. The cationic extractant in the porous sidewall continuously extracts Al from the feed solution while substantially rejecting Li for recovery.

### CROSS-REFERENCE TO RELATED APPLICATIONS

This application claims the benefit of U.S. Provisional Application No. 63/471,289, filed Jun. 6, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of separating lithium from aluminum using membrane solvent extraction.

### BACKGROUND OF THE INVENTION

In recent years, the global demand for lithium (Li) has drawn significant attention due to the accelerated expansion of lithium-ion battery (LIB) industries for their use in portable electronics and hybrid/electric vehicles. Thus, a substantial increase in lithium production capacity is a key priority to meet growing demand. Mining is currently the major source of lithium; however, conventional mining is typically energy and cost intensive. Alternatively, both geothermal brines and leachate solutions from clay minerals are a promising resource for industrial-scale lithium production since they are more environmentally friendly and potentially could be cost-effective. Coal and fly ash, produced water and other acid mine drainage may contain various minerals including lithium (Li), cobalt (Co), rare earth elements (REE), and gallium (Ga). Brine or highly saline water is a valuable source of various minerals including lithium (Li), nickel (Ni), gold (Au), and uranium (U). The vast amount of brine sources worldwide have attracted attention due to their potential to mitigate the rising industrial demand of these minerals while minimizing environmental deterioration. Among the elements extracted from brines and minerals, lithium is considered one of the most essential elements due to several factors including the current and expected commercial demand for lithium in the near future. On the other hand, the low concentration of lithium in brines and leachate solutions in the presence of high salt concentration makes it challenging to obtain a high-purity product. The current state of the art for recovery of lithium from geothermal brines is a sorption-based system which involves a three-step process including extraction, wash, and strip under repeated cycling conditions, which is not efficient from the standpoint of time, energy, and cost. Other methods of separating lithium from other metals include solvent (liquid-liquid) extraction, selective dissolution using a caustic solution such as a NaOH solution, hydrometallurgy, and pyrometallurgy. However, these methods are costly, and may require multiple steps and/or generate large amounts of undesirable waste materials.

Accordingly, there remains a need for an improved method and system for the recovery of lithium from alternate sources, such as geothermal brines and clay minerals, that faster, more energy efficient, and less costly than the current state of the art.

### SUMMARY OF THE INVENTION

A method of separating lithium (Li) from aluminum (Al) is provided. In preferred embodiments, the method includes obtaining an aqueous feed solution containing an acid, Li, and Al. The method further includes providing a membrane module including a plurality of hollow fibers. The plurality of hollow fibers are hydrophobic and include a porous sidewall defining a lumen side spaced apart from a shell side. The method further includes wetting the porous sidewall of the plurality of hollow fibers with an organic phase. The organic phase includes a cationic extractant and an organic solvent, and the organic phase is immobilized in the porous sidewall. The method further includes performing membrane solvent extraction by passing the feed solution along one of the lumen side or the shell side of the plurality of hollow fibers and simultaneously passing a strip solution along the other of the lumen side or the shell side of the plurality of hollow fibers. Wetting the porous sidewall of the plurality of hollow fibers with the organic phase is performed prior to passing the feed solution and passing the strip solution, and the cationic extractant in the porous sidewall continuously extracts Al from the feed solution while substantially rejecting Li for recovery. Several other membrane configurations including flat sheet, spiral wound, and tubular may also be utilized for the separation of Li from Al.

In specific embodiments, the cationic extractant is di-(2-ethylhexyl)phosphoric acid (DEHPA).

In specific embodiments, the concentration of DEHPA is in a range of from 5 vol. % to 60 vol. %.

In specific embodiments, the plurality of hollow fibers are formed from a porous polymer comprising one of polypropylene (PP), polyvinylidene fluoride (PVDF), polyacrylonitrile (PAN), polyetheretherketone (PEEK), polysulfone (PSU), polyvinyl chloride (PVC), and polyether-sulfone (PES). Hollow fibers can also be formed from inorganic membranes including carbon fiber composites, ceramics, molecular sieves, titania, yttria stabilized zirconia, zeolites, alumina and silica.

In specific embodiments, the feed solution is obtained from one of a clay mineral leachate and a geothermal brine.

In specific embodiments, the feed solution and the strip solution are passed in continuous recirculation through the membrane module.

In specific embodiments, the pH of the feed solution is in a range of from 1 to 3.5.

In specific embodiments, the strip solution includes a mineral acid at a molar concentration in a range of from 0.5M to 2.0M.

In specific embodiments, the strip solution has a pH (and/or molarity) that is less than a pH of the feed solution.

In specific embodiments, Li is separated from Al to obtain Li with >94% purity, optionally >99% purity.

A method of recovering lithium from a source solution is also provided. The method includes introducing an aluminum hydroxide sorbent to the source solution to obtain a lithium aluminum sulfate precipitate. The method further includes dissolving the lithium aluminum sulfate precipitate in dilute sulfuric acid to obtain a feed solution containing Li and Al. The method further includes providing a membrane module including a plurality of hollow fibers. The plurality of hollow fibers are hydrophobic and include a porous sidewall defining a lumen side spaced apart from a shell side. The method further includes wetting the porous sidewall of the plurality of hollow fibers with an organic phase. The organic phase includes a cationic extractant and an organic solvent, and the organic phase is immobilized in the porous sidewall. The method further includes performing membrane solvent extraction by passing the feed solution along one of the lumen side or the shell side of the plurality of hollow fibers and simultaneously passing a strip solution along the other of the lumen side or the shell side of the plurality of hollow fibers. Wetting the porous sidewall of the plurality of hollow fibers with the organic phase is performed prior to passing the feed solution and passing the strip solution, and the cationic extractant in the porous sidewall continuously extracts Al from the feed solution while substantially rejecting Li for recovery.

In specific embodiments, the source solution is one of a clay mineral leachate solution and a geothermal brine.

In specific embodiments, the cationic extractant is di-(2-ethylhexyl)phosphoric acid (DEHPA).

In specific embodiments, the concentration of DEHPA is in a range of from 5 vol. % to 60 vol. %.

In specific embodiments, the pH of the feed solution is in a range of from 1 to 3.5.

In specific embodiments, the strip solution includes a mineral acid at a molar concentration in a range of from 0.5M to 2.0M.

In other embodiments, a method of separating lithium from aluminum includes providing a feed solution including Li and Al, the feed solution having a pH of between 2.5 and 3.0. The method further includes providing a membrane module including a plurality of hollow fibers. The plurality of hollow fibers are hydrophobic and include a lumen side spaced apart from a shell side to define a membrane therebetween. The membrane includes a plurality of pores uniformly dispersed therein. The method further includes pre-impregnating the plurality of pores of the membrane for each of the plurality of hollow fibers with an organic phase. The organic phase includes a cationic extractant and an organic solvent. The organic phase is immobilized in the plurality of pores. The method further includes recirculating a continuous flow rate of the feed solution along one of the lumen side or the shell side of the plurality of hollow fibers. The method further includes recirculating a continuous flow rate of a strip solution along the other of the lumen side or the shell side of the plurality of hollow fibers, such that Al is simultaneously back-extracted into the strip solution from the organic phase and Li remains in the feed solution.

In specific embodiments, the cationic extractant is di-(2-ethylhexyl)phosphoric acid (DEHPA).

In specific embodiments, the step of providing the feed solution includes dissolving a lithium aluminum hydroxide-containing precipitate in a mineral acid.

In specific embodiments, the step of directing a continuous flow rate of the feed solution and directing a continuous flow rate of the strip solution are performed for a first predetermined time during a first stage separation. Thereafter, the method further includes converting the strip solution from the first stage separation into a feed solution for a second stage separation by adjusting its pH to between 2.5 and 3.0. The second stage separation includes providing a second membrane module including a plurality of hollow fibers. The plurality of hollow fibers are hydrophobic and include a lumen side spaced apart from a shell side to define a membrane therebetween. The membrane includes a plurality of pores dispersed therein. The second stage separation further includes pre-impregnating the plurality of pores of the membrane for each of the plurality of hollow fibers of the second membrane module with an organic phase. The organic phase includes a cationic extractant and an organic solvent, and the organic phase is immobilized in the plurality of pores. The second stage separation further includes directing a continuous flow rate of the second stage feed solution along one of the lumen side or the shell side of the plurality of hollow fibers of the second membrane module. The second stage separation further includes directing a continuous flow rate of a second stage strip solution along the other of the lumen side or the shell side of the plurality of hollow fibers of the second membrane module. A concentration of Li in the second stage strip solution is greater than the concentration of Li in the first stage strip solution.

These and other features of the invention will be more fully understood and appreciated by reference to the description of the embodiments and the drawings.

### BRIEF DESCRIPTION OF THE DRAWINGS

FIG. 1 is a schematic view of a membrane module in accordance with embodiments of a method of separating lithium (Li) from aluminum (Al) as disclosed herein;

FIG. 2 is a schematic view of a single-stage system including the membrane module of FIG. 1;

FIG. 3 is a graph of the concentration of Li and Al in the strip solution as a function of time for an illustrative example of the method;

FIG. 4 is a graph of the concentration of Li and Al in the feed solution as a function of time for the illustrative example of the method;

FIG. 5 is a graph of the extraction rate of Al from the feed solution as a function of time for the illustrative example of the method; and

FIG. 6 is a graph of the Li purity in the feed solution as a function of time for the illustrative example of the method.

### DETAILED DESCRIPTION OF THE CURRENT EMBODIMENTS

As discussed herein, the current embodiments relate to a method of separating lithium (Li) from aluminum (Al) through membrane assisted solvent extraction. In general terms, the method includes the following steps for single- or multi-stage extraction of aluminum from a feed solution including both lithium and aluminum: a) obtaining an acidic, aqueous feed solution containing both Li and Al; b) providing a membrane module including a plurality of porous hollow fibers; c) wetting the plurality of porous hollow fibers with an organic phase including a cationic extractant and an organic solvent; d) applying a continuous flow rate of the acidic aqueous feed solution, at a predetermined pH, along the lumen side or the shell side of the plurality of porous hollow fibers; and e) applying a continuous flow rate of an acidic strip solution, at a predetermined pH, along the other of the lumen side or the shell side of the plurality of porous hollow fibers. The step of wetting the plurality of porous hollow fibers (step (c)) is performed prior to the steps of applying a flow rate of feed solution and a flow rate of strip solution (steps (d) and (e)). The steps of applying a flow rate of feed solution and a flow rate of strip solution are generally simultaneous. Each step is separately discussed in greater detail below.

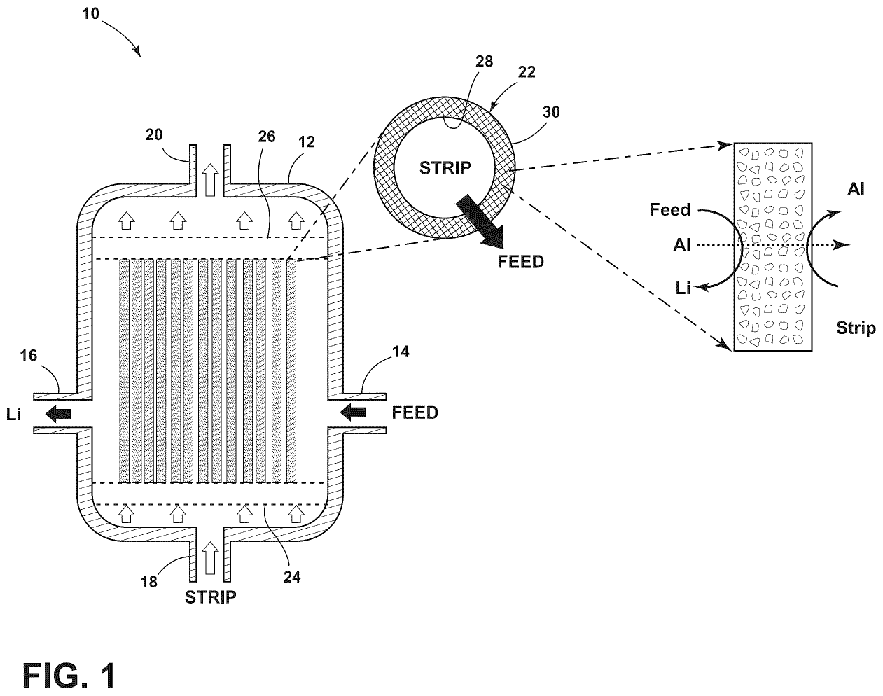

Providing a membrane module generally includes providing a plurality of hollow or tube-like fibers extending between opposing tubesheets. By way of illustration, a membrane module containing a fiber bundle is illustrated in FIG. 1 and generally designated as 10. The membrane module 10 includes an outer casing 12 including a feed input port 14, a feed output port 16, a strip input port 18, and a strip output port 20. A suitable membrane module can include a hydrophobic polypropylene membrane module (Liqui-Cel® by 3M Company) with a membrane module surface area of 1.4 m². However, suitable industrial scale membrane modules may have an active membrane module surface area of up to 20 m². The plurality of hollow fibers 22 are potted to first and second tubesheets 24, 26 at opposing ends thereof, such that the fibers 22 extend in a common direction. Each fiber 22 includes a lumen side 28 and a shell side 30. The lumen side 28 is illustrated in FIG. 1 as being exposed to the strip solution, however in other embodiments the lumen side 28 is exposed to the feed solution. Similarly, the shell side 30 is illustrated in FIG. 1 as being exposed to the feed solution, however in other embodiments the shell side 30 is exposed to the strip solution. As used herein, the “lumen side” includes the interior surface that defines a channel extending longitudinally through the length of the hollow fiber, and the “shell side” includes the exterior surface of the fiber, such that the lumen side and the shell side are spaced apart from each other by the thickness of the membrane sidewall. The side in contact with the feed solution defines the “feed interface,” and the side in contact with the strip solution defines the “strip interface.” The lumen side is the feed interface in some embodiments and is the strip interface in other embodiments. Similarly, the shell side is the strip interface in some embodiments and is the feed interface in other embodiments.

The hollow fibers 22 are porous to retain an organic phase therein and are formed of a material that is highly stable in strong mineral acids and thus able to withstand the acidic conditions in the feed solution and the strip solution. The hollow fibers 22 are formed from a hydrophobic material, which assists in preventing the wetting of the fibers by the aqueous feed solution and which can also prevent the displacement of the organic phase into the strip solution. Hydrophobic materials can include, for example, polypropylene (PP), polyvinylidene fluoride (PVDF), polyacrylonitrile (PAN), polyetheretherketone (PEEK), polyacrylonitrile, polysulfone (PSU), polyvinyl chloride (PVC), and polyether-sulfone (PES). Hollow fibers can also be formed from inorganic membranes including carbon fiber composites, ceramics, molecular sieves, titania, yttria stabilized zirconia, zeolites, alumina and silica. The pore size is selected such that the organic phase containing the extractant is not displaced by contact with a pressurized feed solution at pressures slightly higher (about 2 psi) than the pressure on the strip side of the fibers, optionally less than 5 psi higher than the pressure of the strip solution. The hollow fibers may have a mean pore size of approximately 30 nm in some embodiments, while in other embodiments the mean pore size may be between 10 nm and 50 nm, inclusive. The hollow fibers may have a mean inner diameter of between 0.1 mm and 1.0 mm, inclusive, further optionally between 0.2 mm and 0.3 mm, inclusive. The hollow fibers may have a mean outer diameter of between 0.1 mm and 1.0 mm, inclusive, further optionally between 0.2 mm and 0.4 mm, inclusive.

Wetting the plurality of porous fibers with an organic phase generally includes directing the organic phase through the strip input port 18 for a predetermined period (e.g., one hour) to saturate the fibers with the organic phase. The flow of organic phase is stopped after a sufficient period has elapsed, resulting in an immobilized organic phase within the pores of the plurality of fibers. Particularly, the organic phase is immobilized in the pores of the fibers due to the capillary force and the hydrophobicity of material forming the fibers. After wetting, deionized or distilled water may be circulated through both input ports 14, 18 to wash out excess organic phase from the membrane module 10. The immobilized organic phase includes a cationic extractant (discussed below) and an organic solvent. The organic solvent includes a synthetic isoparaffinic hydrocarbon solvent, for example Isopar-L (Exxon Mobile Corporation). Other immobilized organic phases can be used in other embodiments where desired.

The extractant is selected to extract Al from the feed solution while rejecting Li such that Li remains in the feed solution for subsequent recovery. In some embodiments, the cationic extractant is di-(2-ethylhexyl)phosphoric acid (DEHPA). In other embodiments, the cationic extractant may be Cyanex 936P, Cyanex 923, LIX 54, Tributyl phosphate (TBP), trioctyl phosphine oxide (TOPO), 1-hydroxyethyl-3-methyl imidazolium bis(trifluoromethylsulfonyl) imide [OHEMIM][Ntf2], 1-butyl-3-methylimidazolium bis(trifluoromethylsulfonyl)imide ([C(4)mim][NTf2], iron chloride (FeCl₃), and other phosphorus or phosphinic family of selective extractants, which may selectively extract Li from Al.

DEHPA can extract Al from a feed solution having a pH of between 1 and 3.5, inclusive, optionally between 2.5 and 3.0, inclusive, further optionally between 2.5 and 3.0, inclusive, while substantially rejecting Li. The concentration of DEHPA in the organic phase may be between 5 vol. % to 60 vol. %, inclusive, optionally between 25 vol. % and 35 vol. %, inclusive. However, only a small amount of extractant is required for the separation process due to the small pore volume in the thin-walled hollow fiber configuration.

Directing a continuous flow rate of an acidic aqueous feed solution along the lumen side or the shell side of the plurality of porous hollow fibers includes directing an acidic aqueous feed solution through the feed input port 14. The acidic aqueous feed solution may be obtained from a source solution of a clay mineral leachate or a geothermal brine. Suitable sedimentary clay minerals include but are not limited to hectorite, spodumene (lithium aluminosilicate), petalite (castorite) and lepidolite.

A precipitate then can be obtained from the source solution to extract Li from the source solution by adding an aluminum hydroxide sorbent to form a lithium aluminum double hydroxide (LDH) chloride or an LDH-sulfate. Particularly, lithium aluminum double hydroxide (LDH) chloride can selectively separate lithium from geothermal brines, and other aluminum hydroxide sorbents can selectively extract lithium as LDH-sulfate from clay mineral leachate solutions. Brines containing lithium chloride stream and/or clay mineral leachate containing lithium sulfate stream is the feed for this process. As such, the precipitate includes both Li and Al. An acid, such as dilute sulfuric acid (H₂SO₄), is then added to the precipitate to obtain a feed solution having a pH of between 1.0 and 3.5, inclusive, optionally between 2.5 and 3.5, inclusive, further optionally between 2.5 and 3.0, inclusive. Other acids, such as hydrochloric acid (HCl) or nitric acid (HNO₃), may alternatively be used. The feed solution can be directed through the module 10 along the shell side 30 of each of the plurality of fibers 22 as shown in FIG. 1. Alternatively, the feed solution can be directed through the module 10 along the lumen side 28 of each of the plurality of porous hollow fibers 22.

Directing a continuous flow rate of an acidic aqueous strip solution along the lumen side or the shell side of the plurality of permeable fibers for back-extraction includes directing a strip solution through the strip input port 18. The strip solution is adapted to strip Al that has diffused from the feed interface to the strip interface. The strip solution includes a mineral acid at a molar concentration in a range of from 0.5M to 2.0M, inclusive. The mineral acid may be, for example, H₂SO₄, HNO₃, or HCl. The strip solution is at a higher molar concentration of acid than the feed solution, and thus has a pH that is less than the pH of the feed solution. That is, a concentration gradient and hence a chemical potential gradient is generally formed between feed solution and the strip solution. The strip solution is directed through the interior of the hollow fibers 22 to contact the lumen side 28 thereof as shown in FIG. 1 above, optionally in a direction generally transverse to the flow of the feed solution along the shell side 30. Alternatively, the strip solution can be directed through the module 10 along the shell side 30 of each of the plurality of fibers 22.

While the feed solution and strip solution are simultaneously passed through the shell side and lumen side of the hollow fibers of the membrane module, respectively (or vice versa), the Al dissolved in the feed solution is transported to the interface between the feed solution and the membrane surface where it selectively reacts with the cationic extractant embedded in the membrane pores and forms a complex. The metal organic complex dissolves in the organic solvent of the organic phase and diffuses through the membrane pores due to the concentration gradient. Once the complex reaches the other side of the membrane it is contacted with the strip solution, where it dissociates and releases the Al into the strip solution.

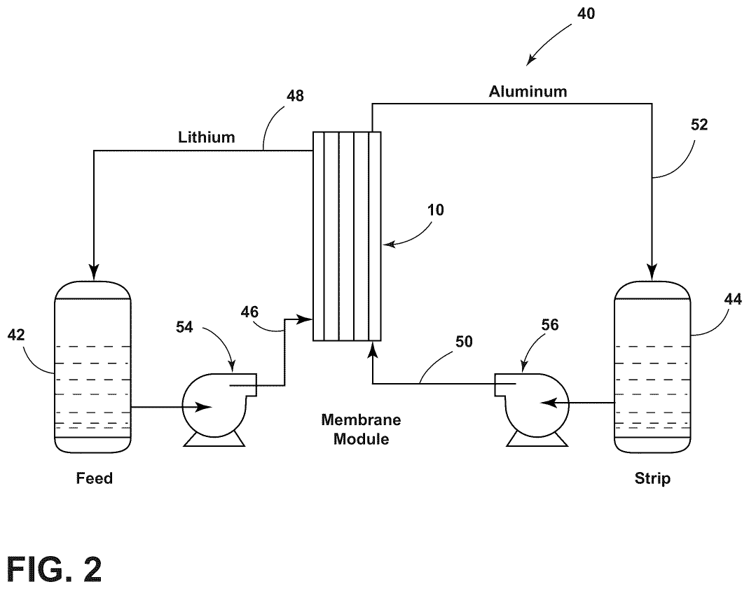

To further illustrate the circulation of the feed solution and the strip solution, a system for membrane assisted solvent extraction is illustrated in FIG. 2 and generally designated as 40. The system 40 includes a feed reservoir 42, a strip reservoir 44, a membrane module 10, a feed line 46, a feed return line 48, a strip line 50, and a strip return line 52. The feed solution is contained within the feed reservoir 42 and kept under constant agitation with a mechanical stirrer to ensure a uniform concentration. The feed line 46 includes a pump 54, for example a peristaltic pump, to ensure the feed line pressure is slightly greater than the strip line pressure. In some applications, the feed can be pressurized up to and including 2 psig, optionally less than 5 psig, while the strip can be maintained at atmospheric pressure. The strip line 50 also includes a pump 56, for example a peristaltic pump, to ensure a continuous flow of strip solution through the module 10. The feed solution and the strip solution are in continuous recirculation, for example, for at least 30 minutes, optionally for a period of at least 1 hour, optionally for a period of at least 12 hours, optionally between 1 hour and 12 hours, inclusive. However, in other embodiments the feed line and/or the strip line form an open circuit.

In other embodiments, the separation of Li from Al can be performed in multiple stages, for example, optionally in two stages, optionally in three stages, and so on. Each stage has the same configuration as shown in FIGS. 1 and 2, and the final feed solution from a preceding stage (e.g., the first stage) is used as the initial feed solution for a subsequent stage (e.g., the second stage). For example, directing a continuous flow rate of a second stage feed solution along one of the lumen side or the shell side of the plurality of hollow fibers of the second membrane module includes obtaining the final first stage feed solution from the first membrane module and using the final first stage feed solution as the initial second stage feed solution. The first stage separation may be conducted for a first predetermined period, for example twelve hours, optionally twenty-four hours, where the feed solution and the strip solution are continuously recirculated through the first membrane module. The second stage of separation can occur over a second predetermined period, optionally less than the first predetermined time period, for example twelve hours, optionally ten hours, optionally six hours, where the feed solution and the strip solution are continuously recirculated through the second membrane module. In each separation stage, the membrane module includes an organic phase as described above, or other combination of the organic phase constituents, and the strip solution includes 0.5M to 2.0M of a mineral acid or other appropriate concentration based on feed solution conditions. At the conclusion of the second or last stage of separation, Li is in substantially pure form, optionally at least 99.0% by weight, being separated from Al. Thus, a multi-stage configuration may increase the purity of the separated Li from a range of approximately 94% or more to a range of approximately 99% or more.

### EXAMPLE

The present method is further described in connection with the following laboratory example, which is intended to be non-limiting.

Hydrophobic polypropylene hollow fiber membrane modules (Liqui-Cel® 2.5×8 Extra-Flow obtained from 3M Company: membrane area of 1.4 m²; ID of 0.24 mm; OD of 0.3 mm; pore size of 30 nm; number of fibers being 10,000; module lumen volume of 150 ml; module shell volume of 400 ml) were used as the microporous membranes. Clay mineral leachate solutions were used as the source of lithium. The predominant constituents of the leachate solutions were lithium, sodium, and potassium in a sulfate stream. Aluminum hydroxide sorbents were used to selectively extract lithium from the clay mineral leachate solutions to obtain a lithium aluminum layered double hydroxide sulfate (LDH-sulfate) precipitate.

Li and Al separation may be impacted by several parameters such as feed pH, concentration of extractant, concentration of strip solution, and feed and strip flow rates. Optimal pH range and strip solution concentration for Al removal were determined by measuring the Al and Li distribution coefficients in di-(2-ethylhexyl)phosphoric acid (DEHPA; obtained from Cytec Industries Inc.) as the organic extractant of the organic phase. Particularly, three 50 mL feed solutions were prepared, each having a concentration of LDH-sulfate in sulfuric acid of 10 g/L. The feed solutions were adjusted to three different feed pH values (pH of 1, 2, and 3) using ammonium hydroxide. Extraction and back-extraction stages were completed by membrane solvent extraction using various concentrations of DEHPA (5 vol. % to 60 vol. % DEHPA in Isopar L isoparaffin obtained from ExxonMobil Chemical) and strip solution molarities (0.5, 1, and 2M sulfuric acid). For the extraction of Al from the feed solution, both the organic phase and the aqueous phase (2 mL each) were mixed for 10 min followed by centrifugation of the mixture for another 10 min. The compositions of the feed solution before and after mixing with the organic phase, and the stripping solution after back extraction were measured using Inductively Coupled Plasma Optical Emission Spectroscopy (ICP-OES). The distribution coefficient for extraction was calculated from the concentration of the target (desired) metal in the organic phase divided by concentration of that metal in the feed solution. Similarly, the distribution coefficient for back-extraction was calculated from the concentration of the target metal in the strip solution divided by the concentration of that metal in the organic phase. The distribution coefficients of the elements are shown in Tables 1-6 below. As can be seen from the data in the tables, the maximum extraction distribution coefficient of Al was 0.2 at a feed pH of 3 and strip solution concentration of 2M. The maximum back-extraction distribution coefficient of Al was 0.97 at a feed pH of 3 and strip solution concentration of 2M (see Tables 5 and 6). No extraction and back-extraction of Li into the strip solution was observed. Further, the results showed that the pH of the feed solution had a significant impact on the extraction rate of Al using DEHPA as the cationic extractant in the organic phase contained in the membrane support. The extraction of Al using DEHPA worked best at a pH of 2.5-3.0. At a pH below 2.5, the extraction rate of Al was found to decrease gradually over time. Based on these results, an optimum pH of 3, strip solution concentration of 2M H₂SO₄, and an organic phase composition of 30% v/v DEHPA in Isopar-L were used as the process parameters in the exemplary membrane solvent extraction process below.

TABLE 1
Distribution coefficient for extraction; extraction of Al
from LDH-sulfate in sulfuric acid with DEHPA and 0.5M strip
solution. DEHPA concentrations are expressed in volume %.

| pH | DEHPA | Strip solution | Li | Al |
|---|---|---|---|---|
| 1 | 5% | 0.5M | 0 | 0 |
| 2 | 5% | 0.5M | 0 | 0.04 |
| 3 | 5% | 0.5M | 0 | 0.12 |
| 1 | 10% | 0.5M | 0 | 0.02 |
| 2 | 10% | 0.5M | 0 | 0.02 |
| 3 | 10% | 0.5M | 0 | 0.10 |
| 1 | 20% | 0.5M | 0 | 0.01 |
| 2 | 20% | 0.5M | 0 | 0.12 |
| 3 | 20% | 0.5M | 0 | 0.23 |
| 1 | 30% | 0.5M | 0 | 0.03 |
| 2 | 30% | 0.5M | 0.01 | 0.12 |
| 3 | 30% | 0.5M | 0 | 0.76 |
| 1 | 40% | 0.5M | 0 | 0.04 |
| 2 | 40% | 0.5M | 0 | 0.05 |
| 3 | 40% | 0.5M | 0 | 0.10 |
| 1 | 50% | 0.5M | 0.02 | 0 |
| 2 | 50% | 0.5M | 0.01 | 0.27 |
| 3 | 50% | 0.5M | 0.01 | 0.33 |
| 1 | 60% | 0.5M | 0.04 | 0.01 |
| 2 | 60% | 0.5M | 0 | 0.23 |
| 3 | 60% | 0.5M | 0 | 0.64 |

TABLE 2
Distribution coefficient for back-extraction; extraction of
Al from LDH-sulfate in sulfuric acid with DEHPA and 0.5M strip
solution. DEHPA concentrations are expressed in volume %.

| pH | DEHPA | Strip solution | Li | Al |
|---|---|---|---|---|
| 1 | 5% | 0.5M | 0 | 0 |
| 2 | 5% | 0.5M | 0 | 0.01 |
| 3 | 5% | 0.5M | 0 | 0.04 |
| 1 | 10% | 0.5M | 0 | 0 |
| 2 | 10% | 0.5M | 0 | 0.01 |
| 3 | 10% | 0.5M | 0 | 0.05 |
| 1 | 20% | 0.5M | 0 | 0 |
| 2 | 20% | 0.5M | 0 | 0.05 |
| 3 | 20% | 0.5M | 0 | 0.1 |
| 1 | 30% | 0.5M | 0 | 0 |
| 2 | 30% | 0.5M | 0 | 0.14 |
| 3 | 30% | 0.5M | 0 | 0.47 |
| 1 | 40% | 0.5M | 0 | 0 |
| 2 | 40% | 0.5M | 0 | 0.02 |
| 3 | 40% | 0.5M | 0 | 0.09 |
| 1 | 50% | 0.5M | 0 | 0 |
| 2 | 50% | 0.5M | 0 | 0.12 |
| 3 | 50% | 0.5M | 0 | 0.17 |
| 1 | 60% | 0.5M | 0 | 0.01 |
| 2 | 60% | 0.5M | 0 | 0.13 |
| 3 | 60% | 0.5M | 0 | 0.23 |

TABLE 3
Distribution coefficient for extraction; extraction of Al
from LDH-sulfate in sulfuric acid with DEHPA and 1M strip
solution. DEHPA concentrations are expressed in volume %.

| pH | DEHPA | Strip solution | Li | Al |
|---|---|---|---|---|
| 1 | 5% | 1M | 0 | 0.03 |
| 2 | 5% | 1M | 0 | 0.12 |
| 3 | 5% | 1M | 0 | 0.26 |
| 1 | 10% | 1M | 0 | 0.03 |
| 2 | 10% | 1M | 0 | 0.20 |
| 3 | 10% | 1M | 0 | 0.38 |
| 1 | 20% | 1M | 0 | 0.03 |
| 2 | 20% | 1M | 0 | 0.19 |
| 3 | 20% | 1M | 0 | 0.25 |
| 1 | 30% | 1M | 0 | 0.10 |
| 2 | 30% | 1M | 0.01 | 0.08 |
| 3 | 30% | 1M | 0 | 0.45 |
| 1 | 40% | 1M | 0 | 0.06 |
| 2 | 40% | 1M | 0 | 0.12 |
| 3 | 40% | 1M | 0 | 0.46 |
| 1 | 50% | 1M | 0 | 0.03 |
| 2 | 50% | 1M | 0.01 | 0.21 |
| 3 | 50% | 1M | 0.01 | 0.38 |
| 1 | 60% | 1M | 0 | 0.05 |
| 2 | 60% | 1M | 0.02 | 0.17 |
| 3 | 60% | 1M | 0.03 | 0.25 |

TABLE 4
Distribution coefficient for back-extraction; extraction of
Al from LDH-sulfate in sulfuric acid with DEHPA and 1M strip
solution. DEHPA concentrations are expressed in volume %.

| pH | DEHPA | Strip solution | Li | Al |
|---|---|---|---|---|
| 1 | 5% | 1M | 0 | 0 |
| 2 | 5% | 1M | 0 | 0.03 |
| 3 | 5% | 1M | 0 | 0.24 |
| 1 | 10% | 1M | 0 | 0 |
| 2 | 10% | 1M | 0 | 0.04 |
| 3 | 10% | 1M | 0 | 0.34 |
| 1 | 20% | 1M | 0 | 0.1 |
| 2 | 20% | 1M | 0 | 0.13 |
| 3 | 20% | 1M | 0 | 0.18 |
| 1 | 30% | 1M | 0 | 0.02 |
| 2 | 30% | 1M | 0 | 0.12 |
| 3 | 30% | 1M | 0 | 0.38 |
| 1 | 40% | 1M | 0 | 0.02 |
| 2 | 40% | 1M | 0 | 0.14 |
| 3 | 40% | 1M | 0 | 0.29 |
| 1 | 50% | 1M | 0 | 0.01 |
| 2 | 50% | 1M | 0 | 0.19 |
| 3 | 50% | 1M | 0 | 0.23 |
| 1 | 60% | 1M | 0 | 0.05 |
| 2 | 60% | 1M | 0 | 0.16 |
| 3 | 60% | 1M | 0 | 0.22 |

TABLE 5
Distribution coefficient for extraction; extraction of Al
from LDH-sulfate in sulfuric acid with DEHPA and 2M strip
solution. DEHPA concentrations are expressed in volume %.

| pH | DEHPA | Strip solution | Li | Al |
|---|---|---|---|---|
| 1 | 5% | 2M | 0 | 0.03 |
| 2 | 5% | 2M | 0 | 0.10 |
| 3 | 5% | 2M | 0 | 0.21 |
| 1 | 10% | 2M | 0 | 0.01 |
| 2 | 10% | 2M | 0 | 0.19 |
| 3 | 10% | 2M | 0 | 0.23 |
| 1 | 20% | 2M | 0 | 0.04 |
| 2 | 20% | 2M | 0 | 0.13 |
| 3 | 20% | 2M | 0 | 0.22 |
| 1 | 30% | 2M | 0 | 0.04 |
| 2 | 30% | 2M | 0.01 | 0.08 |
| 3 | 30% | 2M | 0 | 0.23 |
| 1 | 40% | 2M | 0 | 0.06 |
| 2 | 40% | 2M | 0 | 0.11 |
| 3 | 40% | 2M | 0 | 0.24 |
| 1 | 50% | 2M | 0.01 | 0.03 |
| 2 | 50% | 2M | 0 | 0.25 |
| 3 | 50% | 2M | 0.03 | 0.33 |
| 1 | 60% | 2M | 0 | 0.05 |
| 2 | 60% | 2M | 0.02 | 0.22 |
| 3 | 60% | 2M | 0.06 | 0.35 |

TABLE 6
Distribution coefficient for back-extraction; extraction of
Al from LDH-sulfate in sulfuric acid with DEHPA and 2M strip
solution. DEHPA concentrations are expressed in volume %.

| pH | DEHPA | Strip solution | Li | Al |
|---|---|---|---|---|
| 1 | 5% | 2M | 0 | 0 |
| 2 | 5% | 2M | 0 | 0.02 |
| 3 | 5% | 2M | 0 | 0.04 |
| 1 | 10% | 2M | 0 | 0.01 |
| 2 | 10% | 2M | 0 | 0.21 |
| 3 | 10% | 2M | 0 | 0.15 |
| 1 | 20% | 2M | 0 | 0.04 |
| 2 | 20% | 2M | 0 | 0.09 |
| 3 | 20% | 2M | 0 | 0.57 |
| 1 | 30% | 2M | 0 | 0.06 |
| 2 | 30% | 2M | 0 | 0.24 |
| 3 | 30% | 2M | 0 | 0.97 |
| 1 | 40% | 2M | 0 | 0.04 |
| 2 | 40% | 2M | 0 | 0.12 |
| 3 | 40% | 2M | 0 | 0.23 |
| 1 | 50% | 2M | 0 | 0.01 |
| 2 | 50% | 2M | 0 | 0.19 |
| 3 | 50% | 2M | 0 | 0.17 |
| 1 | 60% | 2M | 0 | 0.05 |
| 2 | 60% | 2M | 0 | 0.15 |
| 3 | 60% | 2M | 0 | 0.28 |

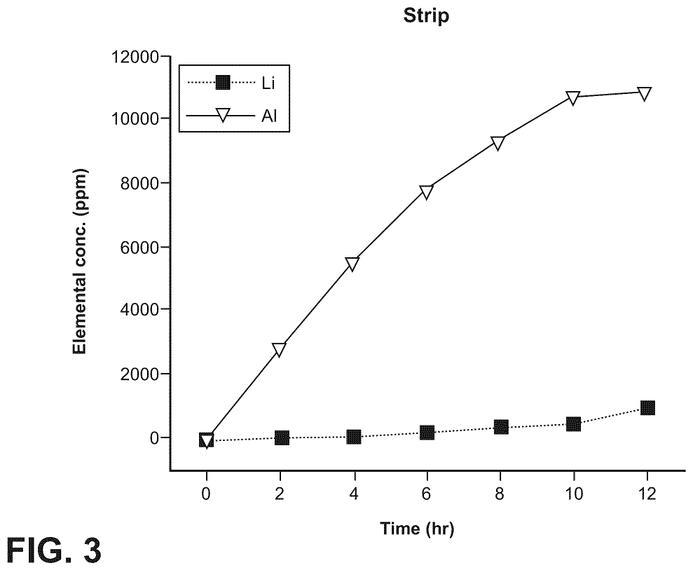

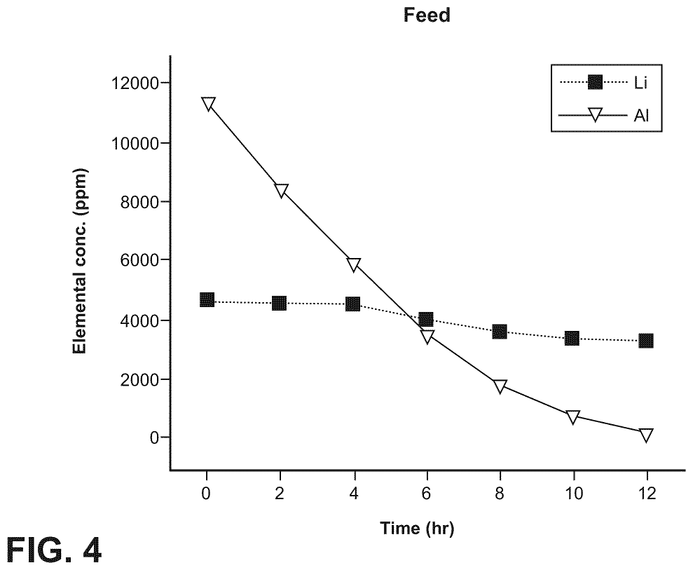

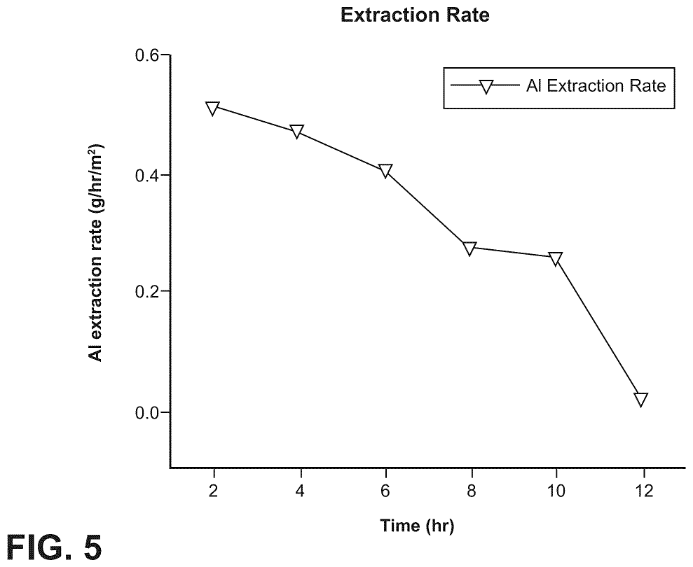

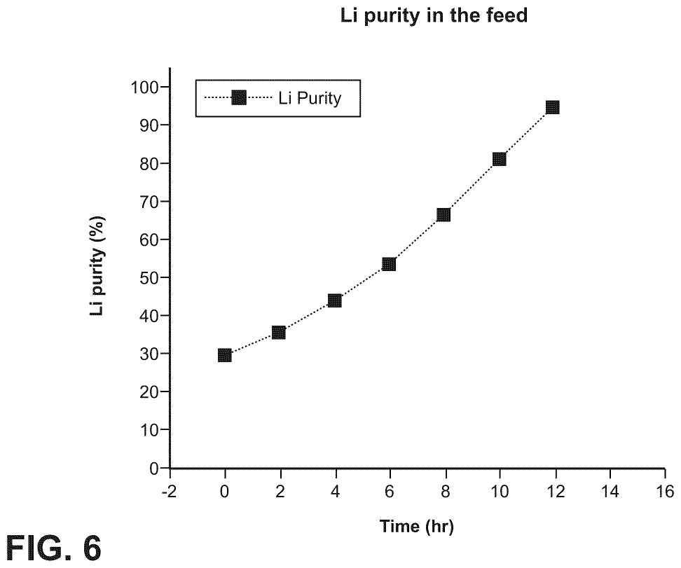

An aqueous feed solution was prepared by dissolving 10 g LDH-sulfate (Li=4750 ppm; Al=11456 ppm) in 500 mL of 0.2M H₂SO₄ (dilute sulfuric acid). Ammonium hydroxide (NH₄OH) was used to adjust the pH of the feed solution to 3. The final feed solution concentration was 20 g/L of LDH-sulfate. The organic phase was 30 vol. % DEHPA as the organic extractant, and 70 vol. % Isopar L as the organic solvent. The organic phase was immobilized in the pores of the hollow fiber membrane module. The strip solution was 500 mL of 2M H₂SO₄. The feed solution containing dissolved LDH-sulfate (with adsorbed lithium) in sulfuric acid and the Al receiving strip solution were passed through the shell and lumen sides of the hollow fibers in the membrane modules at flow rates of approximately 100 mL/min. The DEHPA extractant functioned as a carrier to selectively transport Al from the feed solution to the strip solution, and Al was selectively separated from Li. Periodic addition of ammonium hydroxide to the feed solution was necessary to maintain the pH during the extraction process due to release of hydrogen ions into the feed solution when the metals form a coordination complex with DEHPA. This was monitored and controlled with the help of automated pH controller dosing system. The separation performance of the system is shown in FIGS. 3-6. The Al content in the strip solution increased with time and 92% recovery of Al (Li=966 ppm, Al=10858 ppm) was achieved while maintaining a minimal passage of Li into the strip solution (see FIG. 3). 94% pure Li (Li=3276 ppm, Al=196 ppm) with a yield of about 92% was recovered from membrane solvent extraction on the feed side using DEHPA as the extractant in the organic phase contained in the porous membrane support (see FIG. 4). The extraction rate of Al decreased over time due to the decrease of the concentration of Al in feed solution (see FIG. 5), while the purity of Li in the feed simultaneously increased over time (see FIG. 6). The initial and final concentrations of Li and Al in the feed and strip solutions are shown in Table 7 below.

TABLE 7
Initial and final compositions of the feed and strip solutions
for the separation of Li and Al from LDH sulfate solution.

| | Feed concentrations (ppm) | | Strip concentrations (ppm) | |
|---|---|---|---|---|
| | Li | Al | Li | Al |
| Initial | 4750 | 11456 | 0 | 0 |
| Final | 3276 | 196 | 966 | 10858 |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of separating lithium (Li) from aluminum (Al), the method comprising:
obtaining an aqueous feed solution containing an acid, Li, and Al;
providing a membrane module including a plurality of hollow fibers, the plurality of hollow fibers being hydrophobic and including a porous sidewall defining a lumen side spaced apart from a shell side;
wetting the porous sidewall of the plurality of hollow fibers with an organic phase, the organic phase including a cationic extractant and an organic solvent, whereby the organic phase is immobilized in the porous sidewall; and
performing membrane solvent extraction by passing the feed solution along one of the lumen side or the shell side of the plurality of hollow fibers and simultaneously passing a strip solution along the other of the lumen side or the shell side of the plurality of hollow fibers;
wherein wetting the porous sidewall of the plurality of hollow fibers with the organic phase is performed prior to passing the feed solution and passing the strip solution;
wherein the cationic extractant in the porous sidewall continuously extracts Al from the feed solution while substantially rejecting Li for recovery.

2. The method of claim 1, wherein the cationic extractant is di-(2-ethylhexyl)phosphoric acid (DEHPA).

3. The method of claim 2, wherein the concentration of DEHPA is in a range of from 5 vol. % to 60 vol. %.

4. The method of claim 1, wherein the plurality of hollow fibers are formed from a porous polymer comprising one of polypropylene (PP), polyvinylidene fluoride (PVDF), polyacrylonitrile (PAN), polyetheretherketone (PEEK), polysulfone (PSU), polyvinyl chloride (PVC), and polyether-sulfone (PES).

5. The method of claim 1, wherein the feed solution is obtained from one of a clay mineral leachate and a geothermal brine.

6. The method of claim 1, wherein the feed solution and the strip solution are passed in continuous recirculation through the membrane module.

7. The method of claim 1, wherein the pH of the feed solution is in a range of from 1 to 3.5.

8. The method of claim 1, wherein the strip solution includes a mineral acid at a molar concentration in a range of from 0.5M to 2.0M.

9. The method of claim 1, wherein the strip solution has a pH that is less than a pH of the feed solution.

10. The method of claim 1, wherein Li is separated from Al to obtain Li with >99% purity.

11. A method of recovering lithium from a source solution, the method comprising:
introducing an aluminum hydroxide sorbent to the source solution to obtain a precipitate of lithium aluminum sulfate;
dissolving the lithium aluminum sulfate precipitate in dilute sulfuric acid to obtain a feed solution containing lithium (Li) and aluminum (Al);
providing a membrane module including a plurality of hollow fibers, the plurality of hollow fibers being hydrophobic and including a porous sidewall defining a lumen side spaced apart from a shell side;
wetting the porous sidewall of the plurality of hollow fibers with an organic phase, the organic phase including a cationic extractant and an organic solvent, whereby the organic phase is immobilized in the porous sidewall; and
performing membrane solvent extraction by passing the feed solution along one of the lumen side or the shell side of the plurality of hollow fibers and simultaneously passing a strip solution along the other of the lumen side or the shell side of the plurality of hollow fibers;
wherein wetting the porous sidewall of the plurality of hollow fibers with the organic phase is performed prior to passing the feed solution and passing the strip solution;
wherein the cationic extractant in the porous sidewall continuously extracts Al from the feed solution while substantially rejecting Li for recovery.

12. The method of claim 11, wherein the source solution is one of a clay mineral leachate solution and a geothermal brine.

13. The method of claim 11, wherein the cationic extractant is di-(2-ethylhexyl)phosphoric acid (DEHPA).

14. The method of claim 13, wherein the concentration of DEHPA is in a range of from 5 vol. % to 60 vol. %.

15. The method of claim 11, wherein the pH of the feed solution is in a range of from 1 to 3.5.

16. The method of claim 11, wherein the strip solution includes a mineral acid at a molar concentration in a range of from 0.5M to 2.0M.

17. A method of separating lithium (Li) from aluminum (Al), the method comprising:
providing a feed solution including Li and Al, the feed solution having a pH of between 2.5 and 3.0;
providing a membrane module including a plurality of hollow fibers, the plurality of hollow fibers being hydrophobic and including a lumen side spaced apart from a shell side to define a membrane therebetween, the membrane including a plurality of pores dispersed therein;
pre-impregnating the plurality of pores of the membrane for each of the plurality of hollow fibers with an organic phase, the organic phase including a cationic extractant and an organic solvent, whereby the organic phase is immobilized in the plurality of pores;
recirculating a continuous flow rate of the feed solution along one of the lumen side or the shell side of the plurality of hollow fibers; and
recirculating a continuous flow rate of a strip solution along the other of the lumen side or the shell side of the plurality of hollow fibers, wherein Al is simultaneously back-extracted into the strip solution from the organic phase and Li remains in the feed solution.

18. The method of claim 17, wherein the cationic extractant is di-(2-ethylhexyl)phosphoric acid (DEHPA).

19. The method of claim 17, wherein providing the feed solution includes dissolving a lithium aluminum hydroxide-containing precipitate in a mineral acid.

20. The method of claim 17, wherein directing a continuous flow rate of the feed solution and directing a continuous flow rate of the strip solution are performed for a first predetermined period during a first stage separation, and thereafter the method further including converting the strip solution from the first stage separation into a feed solution for a second stage separation by adjusting its pH to between 2.5 and 3.0;
the second stage separation including:
providing a second membrane module including a plurality of hollow fibers, the plurality of hollow fibers being hydrophobic and including a lumen side spaced apart from a shell side to define a membrane therebetween, the membrane including a plurality of pores dispersed therein;
pre-impregnating the plurality of pores of the membrane for each of the plurality of hollow fibers of the second membrane module with an organic phase, the organic phase including a cationic extractant and an organic solvent, whereby the organic phase is immobilized in the plurality of pores;
directing a continuous flow rate of the second stage feed solution along one of the lumen side or the shell side of the plurality of hollow fibers of the second membrane module; and
directing a continuous flow rate of a second stage strip solution along the other of the lumen side or the shell side of the plurality of hollow fibers of the second membrane module, wherein a concentration of Li in the second stage strip solution is greater than the concentration of Li in the first stage strip solution.
